(19) United States
(12) Patent Application Publication
(10) Pub. No.: US 2025/0379512 A1
(43) Pub. Date: Dec. 11, 2025

(54) CONVERTER BREAKER FOR ENABLING A CONVERTER TO TOLERATE A VOLTAGE SURGE

(71) Applicant: Infinity Miles, Inc., CUBA, MO (US)

(72) Inventors: Siavash Sadeghi, Irvine, CA (US); Pourya Shamsi, Rolla, MO (US)

(21) Appl. No.: 19/232,508

(22) Filed: Jun. 9, 2025

Related U.S. Application Data
(60) Provisional application No. 63/657,630, filed on Jun. 7, 2024.

(51) Int. Cl. H02M 1/34; H02M 1/00

(52) U.S. Cl. CPC H02M 1/344; H02M 1/007

(57) ABSTRACT

The present disclosure provides a converter breaker for enabling a converter to tolerate a voltage surge. Further, the converter breaker may include a switch module which may be configured to be transitioned between an on state and an off state. Further, the switch module may be configured for allowing a conduction of a current through the switch module during the on state and restricting the conduction of the current in the off state. Further, the converter breaker may include a capacitor connected to the switch module in a parallel connection with the switch module. Further, the capacitor may be configured for limiting a ramp of a voltage rise in the off state of the switch module. Further, the converter breaker may include a varistor which may be configured for clamping a maximum voltage applied to the converter breaker in the off state of the switch module.

### FIELD OF DISCLOSURE

The present disclosure generally relates to the field of electricity: circuit makers and breakers. More specifically, the present disclosure relates to a converter breaker for enabling a converter to tolerate a voltage surge.

### BACKGROUND

The field of power conversion and protection is critical in modern industrial systems, particularly in applications involving renewable energy sources such as solar and wind power. These systems rely heavily on inverters and converters to interface with the grid, ensuring stable and reliable power output. However, one of the most challenging aspects of these systems is protecting components from voltage spikes and surges that can cause significant damage and disrupt operations.

For cascaded H-bridge multi-level inverters, the AC/DC module can get exposed to lightning and switch overvoltage. Currently, the mechanical device fails to be fast enough to protect a converter using traditional breaker modules. Further, the converter's capacity is not sufficient to tolerate the lightning overvoltage since the existing MOV technologies usually limit the maximum voltage to 2.5-3 times the nominal grid's peak voltage. Existing systems often struggle with this challenge due to several limitations. First, traditional surge protection methods may require additional cascaded H-bridge levels, which not only increase complexity but also add significant costs. These configurations can be cumbersome to scale and may not effectively address the needs of high-power applications. However, this extra voltage tolerance is only needed during the breaking period when a lightning surge is detected. Hence, during normal operation, added cascade levels are underused and there is no benefit in having them.

Additionally, conventional approaches may lack the necessary sophistication to handle real-time voltage fluctuations and provide adequate protection against surges without degrading performance. Moreover, existing systems may lack the flexibility to integrate advanced protective measures, which could significantly improve overall system reliability and efficiency.

Therefore, there is a need for improved a converter breaker for enabling a converter to tolerate a voltage surge, that may overcome one or more of the above-mentioned problems and/or limitations.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a converter breaker for enabling a converter to tolerate a voltage surge. Further, the converter breaker may include a switch module which may be configured to be transitioned between an on state and an off state. Further, the switch module may be configured for allowing a conduction of a current through the switch module during the on state. Further, the switch module may be configured for restricting the conduction of the current through the switch module in the off state. Further, the converter breaker may include a capacitor connected to the switch module in a parallel connection with the switch module. Further, the capacitor may be configured for limiting a ramp of a voltage rise in the off state of the switch module. Further, the converter breaker may include a varistor connected to the capacitor and the switch module in a parallel connection with the capacitor and the switch module. Further, the varistor may be configured for clamping a maximum voltage applied to the converter breaker in the off state of the switch module.

The present disclosure provides a converter breaker for enabling a converter to tolerate a voltage surge. Further, the converter breaker may include a switch module which may be configured to be transitioned between an on state and an off state. Further, the switch module may be configured for allowing a conduction of a current through the switch module during the on state. Further, the switch module may be configured for restricting the conduction of the current through the switch module in the off state. Further, the switch module may include a first switch unit comprising each of a first switch and a first diode. Further, the first diode may be connected to the first switch in a parallel connection with the first switch. Further, the switch module may include a second switch unit may be connected to the first switch unit. Further, the second switch unit includes each of a second switch and a second diode. Further, the second diode may be connected to the second switch in a parallel connection with the second switch. Further, the converter breaker may include a capacitor connected to the switch module in a parallel connection with the switch module. Further, the capacitor may be configured for limiting a ramp of a voltage rise in the off state of the switch module. Further, the converter breaker may include a varistor connected to the capacitor and the switch module in a parallel connection with the capacitor and the switch module. Further, the varistor may be configured for clamping a maximum voltage applied to the converter breaker in the off state of the switch module.

The present disclosure provides a converter breaker for enabling a converter to tolerate a voltage surge. Further, the converter breaker may include a switch module which may be configured to be transitioned between an on state and an off state. Further, the switch module may be configured for allowing a conduction of a current through the switch module during the on state. Further, the switch module may be configured for restricting the conduction of the current through the switch module in the off state. Further, the converter breaker may include a capacitor connected to the switch module in a parallel connection with the switch module. Further, the capacitor may be configured for limiting a ramp of a voltage rise in the off state of the switch module. Further, the converter breaker may include a varistor connected to the capacitor and the switch module in a parallel connection with the capacitor and the switch module. Further, the varistor may be configured for clamping a maximum voltage applied to the converter breaker in the off state of the switch module. Further, the converter breaker includes a number of converter breakers. Further, the converter includes a number of H-bridge modules. Further, the number of H-bridge modules may be cascadedly connected. Further, each of the number of converter breakers may be configured to be serially connected to each of a number of H-bridge modules of the converter respectively.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of a converter breaker 100 for enabling a converter to tolerate a voltage surge, in accordance with some embodiments.

FIG. 2 illustrates the converter breaker 100, in accordance with some embodiments.

FIG. 3 illustrates a first configuration 300 of a number of converter breakers 306-310 with a converter 304 and a power source 302, in accordance with some embodiments.

FIG. 4 illustrates a second configuration 400 of a plurality of sets of converter breakers 406-412 with a converter 404 and a power source 402, in accordance with some embodiments.

FIG. 5 illustrates a converter 504, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

### Overview

The present disclosure relates to a multi-level converter breaker. The multi-level converter breaker may include a breaker module that increases the converter's maximum input voltage tolerance capacity without adding additional cascaded H-bridge levels that lead to more cost. The breaker module may include a back-to-back switch formation to allow for the conduction of current during normal operation. These switches may be associated with the same rating as the cascaded H-bridge switches. So, each module adds equivalent to 1 cascade level but at a much lower cost. Further, the breaker module may include a capacitor to limit the ramp of the voltage rise when the switches open to prevent excessive switching energy from being dissipated on the semiconductor devices.

Further, the breaker module may include varistors (MOV) to clamp the maximum voltage on the module to prevent the breakdown of the semiconductor devices. The multi-level converter breaker may add higher voltage breaking capability to conventional cascaded H-bridge grid-tied inverters used in medium- and high-voltage applications. The multi-level converter breaker may increase the voltage tolerance of the inverter during the breaking period by introducing breaking and clamping modules. The modules are by-passed using their internal back-to-back bi-directional switches. Hence, the breaker module has minimum impact on the normal operation of the device. When breaking under surge voltages is needed, the modules are activated by turning off their bypass back-to-back switches and effectively placing the capacitor and varistor in series with the current path.

The overall converter may be able to tolerate a maximum surge voltage equal to N times the cascaded H-bridge's voltage rating plus M times the breaker module's clamped voltage rating. N is the number of cascaded h-bridges in each phase and M is the total number of breaker modules used in each phase. The internal capacitor may limit the voltage ramp rate on the internal switches. The internal varistor may clamp the maximum voltage dropping on each breaker module to a safe limit. The modules may be placed in various formations with quantities as needed to tolerate the maximum surge voltage of the input grid. Based on existing grid protection technologies, 2.5-3× of the max nominal voltage is the clamping voltage provided by grid surge arresters. Hence, adding two breaker modules per cascaded h-bridge level is the minimum recommendation that may be placed in the form of the first configuration.

Further, the multi-level converter breaker may reduce the total cost needed to tolerate a high-voltage surge by eliminating the need for an additional cascaded H-bridge module. Further, the multi-level converter breaker may be added to existing cascaded H-bridge systems to increase their voltage tolerance.

Further, the breaker module may include sensors and data analytics tools that continuously assess system health and voltage conditions. This allows for proactive adjustments to protect against surges before they occur.

Further, the breaker module may employ fault-tolerant switching mechanisms that ensure uninterrupted power supply during failures. These mechanisms could automatically reroute current through alternative paths or activate backup systems, minimizing downtime and enhancing system reliability.

Further, the breaker module may include an active voltage balancing system that actively regulates and stabilizes voltage levels by dynamically adjusting reactive power outputs or absorbing excess voltage through specialized components.

Further, the breaker module may include mechanisms that not only isolate faults but also reset affected components once the issue is resolved. This approach minimizes downtime and ensures rapid recovery times.

Further, the breaker module can be designed with a modular scalability feature. Users can add or remove modules as needed, allowing for flexible configurations that suit different application environments without compromising protection capabilities.

Further, the breaker module may integrate thermal management systems that monitor and regulate temperatures in real-time, activating cooling mechanisms when thresholds are reached to prevent damage and ensure continued operation.

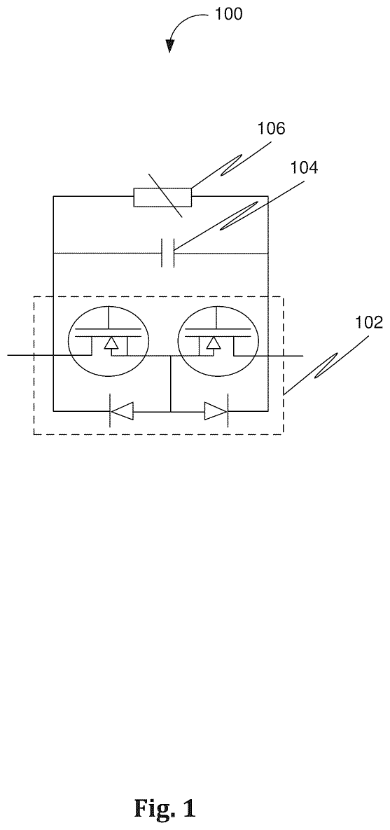

FIG. 1 is an illustration of a converter breaker 100 for enabling a converter to tolerate a voltage surge, in accordance with some embodiments.

Accordingly, the converter breaker 100 may include a switch module 102 which may be configured to be transitioned between an on state and an off state. Further, the switch module 102 may be configured for allowing a conduction of a current through the switch module 102 during the on state. Further, the switch module 102 may be configured for restricting the conduction of the current through the switch module 102 in the off state. Further, the converter breaker 100 may include a capacitor 104 connected to the switch module 102 in a parallel connection with the switch module 102. Further, the capacitor 104 may be configured for limiting a ramp of a voltage rise in the off state of the switch module 102. Further, the converter breaker 100 may include a varistor 106 connected to the capacitor 104 and the switch module 102 in a parallel connection with the capacitor 104 and the switch module 102. Further, the varistor 106 may be configured for clamping a maximum voltage applied to the converter breaker 100 in the off state of the switch module 102.

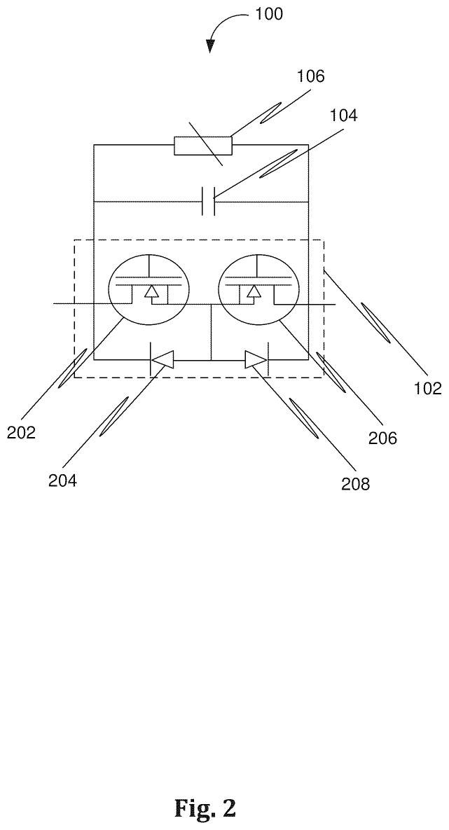

FIG. 2 illustrates the converter breaker 100, in accordance with some embodiments.

Further, in some embodiments, the switch module 102 may include a first switch unit comprising each of a first switch 202 and a first diode 204. Further, the first diode 204 may be connected to the first switch 202 in a parallel connection with the first switch 202. Further, the switch module 102 may include a second switch unit that may be connected to the first switch unit. Further, the second switch unit includes each of a second switch 206 and a second diode 208. Further, the second diode 208 may be connected to the second switch 206 in a parallel connection with the second switch 206.

In some embodiments, each of the first switch 202 and the second switch 206 may be a bi-directional switch.

In some embodiments, the first switch unit and the second switch unit may be connected back-to-back in series.

In some embodiments, the converter breaker 100 may have a voltage rating similar to a voltage rating of each of the number of H-bridge modules.

In some embodiments, the allowing of the conduction of the current through the switch module 102 during the on state includes allowing of a conduction of a first current through a first switch unit in a first direction during the on state of the first switch unit. Further, the allowing of the conduction of the current through the switch module 102 during the on state includes allowing a conduction of the first current through a second switch unit in a second direction during the on state of the second switch unit. Further, the first direction may be different from the second direction. Further, the current includes the first current.

In some embodiments, the restricting of the conduction of the current through the switch module 102 in the off state includes restricting a conduction of a second current through the first switch unit in the first direction in the off state of the first switch unit. Further, the restricting of the conduction of the current through the switch module 102 in the off state includes restricting a conduction of the second current through the second switch unit in the second direction in the off state of the second switch unit. Further, the current includes the second current. Further, the first current may be different from the second current.

In some embodiments, the first current and the second current may be associated with a first voltage and a second voltage respectively. Further, the first voltage includes a normal operating voltage of the converter 100. Further, the second voltage may be greater than the normal operating voltage.

In some embodiments, the second voltage corresponds to the voltage surge.

In some embodiments, the first switch 202 and the second switch 206 include a first Metal Oxide Semiconductor Field Effect Transistor (MOSFET) switch and a second Metal Oxide Semiconductor Field Effect Transistor (MOSFET) switch respectively.

In some embodiments, the first MOSFET switch and the second MOSFET switch include a first negative MOSFET (n-MOSFET) switch and a second negative MOSFET (n-MOSFET) switch respectively.

In some embodiments, the first diode 204 may be forward biased with respect to the first switch 202. Further, the second diode 208 may be forward biased with respect to the second switch 206.

In some embodiments, the varistor 106 includes a Metal Oxide Varistor (MOV).

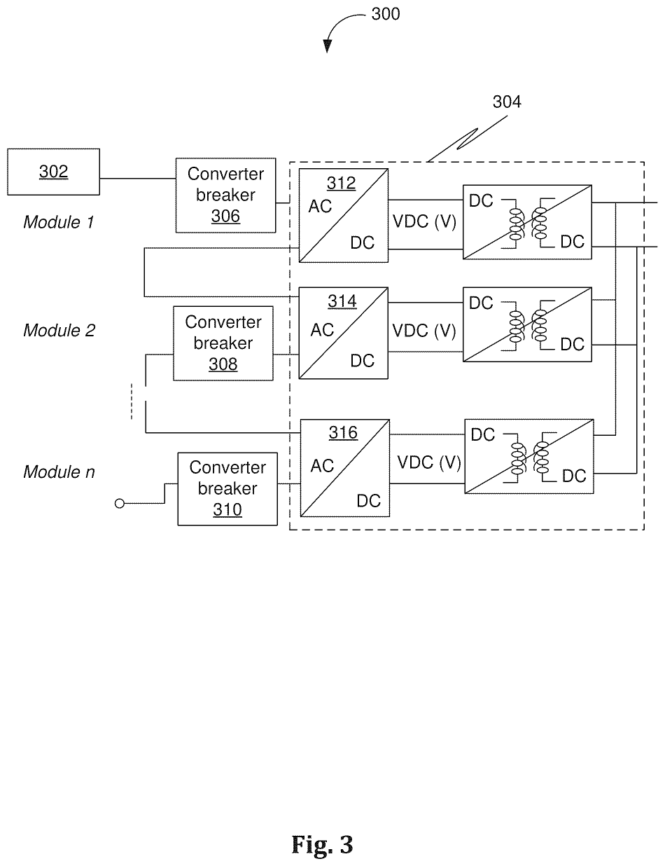

FIG. 3 illustrates a first configuration 300 of a number of converter breakers 306-310 with a converter 304 and a power source 302, in accordance with some embodiments.

In some embodiments, the converter breaker 100 includes the number of converter breakers 306-310. Further, the converter 304 includes a number of H-bridge modules 312-316. Further, the number of H-bridge modules 312-316 may be cascadedly connected. Further, each of the number of converter breakers 306-310 may be configured to be serially connected to each of a number of H-bridge modules 312-316 of the converter respectively.

In some embodiments, the number of H-bridge modules 312-316 includes a first H-bridge module 312 and one or more second H-bridge modules 314 and 316. Further, the first H-bridge module 312 may be connected to a power source 302 through a first converter breaker 306 of the number of converter breakers 306-310. Further, the first H-bridge module 312 and the one or more second H-bridge modules 314 and 316 may be cascadedly connected through one or more second converter breakers 308 and 310 of the number of converter breakers 306-310.

In some embodiments, each of the number of H-bridge modules 312-316 and the number of H-bridge modules 312-316 in the first configuration 300 may be connected to each phase of the power source 302.

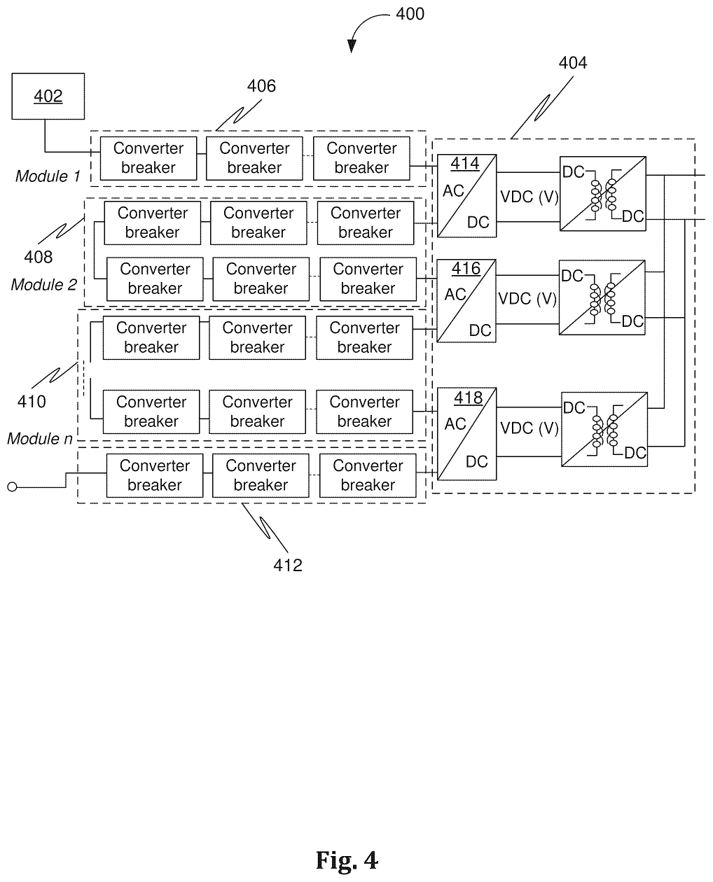

FIG. 4 illustrates a second configuration 400 of two or more sets of converter breakers 406-412 with a converter 404 and a power source 402, in accordance with some embodiments.

In some embodiments, the converter breaker 100 includes the two or more sets of converter breakers 406-412.

In some embodiments, the converter 304 includes a number of H-bridge modules 414-418 comprising a first H-bridge module 414, one or more second H-bridge modules 416, and a third H-bridge module 418. Further, the first H-bridge module 414 may be connected to a power source 402 through a first set of converter breakers 406 of the two or more sets of converter breakers 406-412. Further, the first H-bridge module 414, the one or more second H-bridge modules 416, and the third H-bridge module 418 may be cascadedly connected through two or more second sets of converter breakers 408 and 410 of the two or more sets of converter breakers 406-412. Further, the third H-bridge module 418 may be connected to a ground through a third set of converter breakers 412 of the two or more converter breakers 406-412.

In some embodiments, each of the first set of converter breakers 406 and the third set of converter breakers 412 includes a N number of converter breakers. Further, each of the two or more second sets of converter breakers 408 and 410 include a 2N number of converter breakers.

Accordingly, the converter breaker 100 may include a switch module 102 which may be configured to be transitioned between an on state and an off state. Further, the switch module 102 may be configured for allowing a conduction of a current through the switch module 102 during the on state. Further, the switch module 102 may be configured for restricting the conduction of the current through the switch module 102 in the off state. Further, the switch module 102 may include a first switch unit comprising each of a first switch 202 and a first diode 204. Further, the first diode 204 may be connected to the first switch in a parallel connection with the first switch 202. Further, the switch module 102 may be configured for allowing a conduction of a current through the switch module 102 during the on state. Further, the switch module 102 may include a second switch unit may be connected to the first switch unit. Further, the second switch unit includes each of a second switch 206 and a second diode 208. Further, the second diode 208 may be connected to the second switch 206 in a parallel connection with the second switch 206. Further, the converter breaker 100 may include a capacitor 104 connected to the switch module 102 in a parallel connection with the switch module 102. Further, the capacitor 104 may be configured for limiting a ramp of a voltage rise in the off state of the switch module 102. Further, the converter breaker 100 may include a varistor 106 connected to the capacitor 104 and the switch module 102 in a parallel connection with the capacitor 104 and the switch module 102. Further, the varistor 106 may be configured for clamping a maximum voltage applied to the converter breaker 100 in the off state of the switch module 102.

Accordingly, the converter breaker 100 may include a switch module 102 which may be configured to be transitioned between an on state and an off state. Further, the switch module 102 may be configured for allowing a conduction of a current through the switch module 102 during the on state. Further, the switch module 102 may be configured for restricting the conduction of the current through the switch module 102 in the off state. Further, the converter breaker 100 may include a capacitor 104 connected to the switch module 102 in a parallel connection with the switch module 102. Further, the capacitor 104 may be configured for limiting a ramp of a voltage rise in the off state of the switch module 102. Further, the converter breaker 100 may include a varistor 106 connected to the capacitor 104 and the switch module 102 in a parallel connection with the capacitor 104 and the switch module 102. Further, the varistor 106 may be configured for clamping a maximum voltage applied to the converter breaker 100 in the off state of the switch module 102. Further, the converter breaker 100 includes a number of converter breakers 306-310. Further, the converter 304 includes a number of H-bridge modules 312-316. Further, the number of H-bridge modules 312-316 may be cascadedly connected. Further, each of the number of converter breakers 306-310 may be configured to be serially connected to each of a number of H-bridge modules 312-316 of the converter respectively.

In some embodiments, each of the number of H-bridge modules includes each of one or more H-bridge inverters and one or more dual-active bridge converters. Further, the one or more dual active bridge converters may be connected to the one or more H-bridge inverters in a series connection with the one or more H-bridge inverters.

In some embodiments, the one or more H-bridge inverters may be configured for converting an alternating current (AC) to a direct current (DC). Further, the current includes the AC. Further, the one or more dual-active bridge converters may be configured for converting a first DC to a second DC. Further, the DC includes the first DC associated with a first DC voltage. Further, the second DC may be associated with a second DC voltage. Further, the first DC voltage may be different from the second DC voltage.

In some embodiments, the power source 302 includes one or more electrical grids which may be configured for transmitting the current from a power plant to one or more receivers comprising the converter breaker 100.

In some embodiments, the one or more electrical grids include one or more medium voltage grids. Further, the transmitting of the current includes transmitting of the current associated with a medium voltage.

In some embodiments, the second current associated with the second voltage may be caused by one or more lightning strikes. Further, a power source 302 of the current may be exposed to the one or more lightning strikes.

In some embodiments, the converter breaker 100 includes a multi-level converter breaker.

In some embodiments, the converter 304 associated with the converter breaker may be characterized by a tolerance voltage. Further, the tolerance voltage includes a value equal to a sum of N times of the voltage rating of the number of H-bridge modules 312-316 and M times of a clamped voltage rating of the number of converter breakers 306-310.

In some embodiments, the N corresponds to the number of H-bridge modules in each phase. Further, the M corresponds to the number of converter breakers in each phase.

In some embodiments, the one or more medium voltage grids include a three phase medium voltage grid.

In some embodiments, the switch module 102 may be configured to be transitioned between the on state and the off state based on a control signal. Further, the control signal triggers the switch module 102 to be in at least one of the on state and the off state. Further, the control signal may be based on a voltage of the current.

In some embodiments, the converter breaker may include a breaker module.

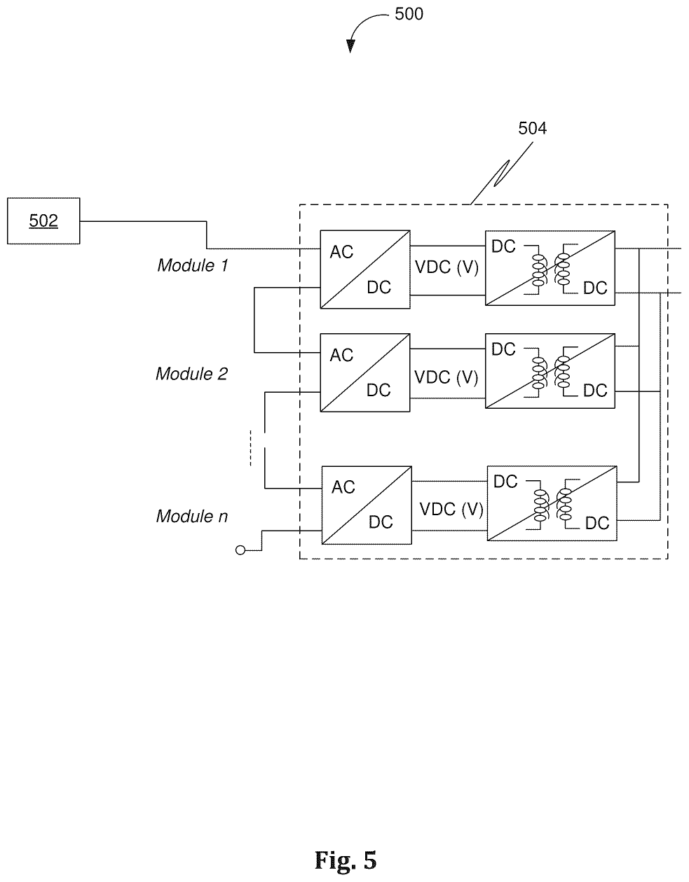

FIG. 5 illustrates a converter 504, in accordance with some embodiments, Further, the converter 304 may be directly connected to a power source 502.

Although the invention has been explained in relation to its preferred embodiment, it is to be understood that many other possible modifications and variations can be made without departing from the spirit and scope of the invention as hereinafter claimed.

What is claimed is:

1. A converter breaker for enabling a converter to tolerate a voltage surge, the converter breaker comprising:
a switch module configured to be transitioned between an on state and an off state, wherein the switch module is configured for allowing a conduction of a current through the switch module during the on state, wherein the switch module is configured for restricting the conduction of the current through the switch module in the off state;
a capacitor connected to the switch module in a parallel connection with the switch module, wherein the capacitor is configured for limiting a ramp of a voltage rise in the off state of the switch module; and
a varistor connected to the capacitor and the switch module in a parallel connection with the capacitor and the switch module, wherein the varistor is configured for clamping a maximum voltage applied to the converter breaker in the off state of the switch module.

2. The converter breaker of claim 1, wherein the switch module comprises:
a first switch unit comprising each of a first switch and a first diode, wherein the first diode is connected to the first switch in a parallel connection with the first switch; and
a second switch unit is connected to the first switch unit, wherein the second switch unit comprises each of a second switch and a second diode, wherein the second diode is connected to the second switch in a parallel connection with the second switch.

3. The converter breaker of claim 2, wherein each of the first switch and the second switch is a bi-directional switch.

4. The converter breaker of claim 2, wherein the first switch unit and the second switch are connected back-to-back in series.

5. The converter breaker of claim 1, wherein the converter breaker comprises a number of converter breakers, wherein the converter comprises a number of H-bridge modules, wherein the number of H-bridge modules are cascadedly connected, wherein each of the number of converter breakers is configured to be serially connected to each of a number of H-bridge modules of the converter respectively.

6. The converter breaker of claim 5, wherein the number of H-bridge modules comprises a first H-bridge module and at least one second H-bridge module, wherein the first H-bridge module is connected to a power source through a first converter breaker of the number of converter breakers, wherein the first H-bridge module and the at least one second H-bridge module are cascadedly connected through at least one second converter breaker of the number of converter breakers.

7. The converter breaker of claim 1, wherein the converter breaker comprises a plurality of sets of converter breakers.

8. The converter breaker of claim 7, wherein the converter comprises a number of H-bridge modules comprising a first H-bridge module, at least one second H-bridge module, and a third H-bridge module, wherein the first H-bridge module is connected to a power source through a first set of converter breakers of the plurality of sets of converter breakers, wherein the first H-bridge module, the at least one second H-bridge module, and the third H-bridge module are cascadedly connected through two or more second sets of converter breakers of the plurality of sets of converter breakers, wherein the third H-bridge module is connected to a ground through a third set of converter breakers of the plurality of converter breakers.

9. The converter breaker of claim 8, wherein each of the first set of converter breakers and the third set of converter breakers comprises a N number of converter breakers, wherein each of the two or more second sets of converter breaker comprises a 2N number of converter breakers.

10. The converter breaker of claim 5, wherein the converter breaker has a voltage rating similar to a voltage rating of each of the number of H-bridge modules.

11. The converter breaker of claim 2, wherein the allowing of the conduction of the current through the switch module during the on state comprises allowing of a conduction of a first current through a first switch unit in a first direction during the on state of the first switch unit, wherein the allowing of the conduction of the current through the switch module during the on state comprises allowing of a conduction of the first current through a second switch unit in a second direction during the on state of the second switch unit, wherein the first direction is different from the second direction, wherein the current comprises the first current.

12. The converter breaker of claim 11, wherein the restricting of the conduction of the current through the switch module in the off state comprises restricting of a conduction of a second current through the first switch unit in the first direction in the off state of the first switch unit, wherein the restricting of the conduction of the current through the switch module in the off state comprises restricting of a conduction of the second current through the second switch unit in the second direction in the off state of the second switch unit, wherein the current comprises the second current, wherein the first current is different from the second current.

13. The converter breaker of claim 12, wherein the first current and the second current is associated with a first voltage and a second voltage respectively, wherein the first voltage comprises a normal operating voltage of the converter, wherein the second voltage is greater than the normal operating voltage.

14. The converter breaker of claim 13, wherein the second voltage corresponds to the voltage surge.

15. The converter breaker of claim 2, wherein the first switch and the second switch comprises a first Metal Oxide Semiconductor Field Effect Transistor (MOSFET) switch and a second Metal Oxide Semiconductor Field Effect Transistor (MOSFET) switch respectively.

16. The converter breaker of claim 15, wherein the first MOSFET switch and the second MOSFET switch comprise a first negative MOSFET (n-MOSFET) switch and a second negative MOSFET (n-MOSFET) switch respectively.

17. The converter breaker of claim 2, wherein the first diode is forward biased with respect to the first switch, wherein the second diode is forward biased with respect to the second switch.

18. The converter breaker of claim 2, wherein the varistor comprises a Metal Oxide Varistor (MOV).

19. A converter breaker for enabling a converter to tolerate a voltage surge, the converter breaker comprising:
a switch module configured to be transitioned between an on state and an off state, wherein the switch module is configured for allowing a conduction of a current through the switch module during the on state, wherein the switch module is configured for restricting the conduction of the current through the switch module in the off state, wherein the switch module comprises:
a first switch unit comprising each of a first switch and a first diode, wherein the first diode is connected to the first switch in a parallel connection with the first switch; and
a second switch unit is connected to the first switch unit, wherein the second switch unit comprises each of a second switch and a second diode, wherein the second diode is connected to the second switch in a parallel connection with the second switch;
a capacitor connected to the switch module in a parallel connection with the switch module, wherein the capacitor is configured for limiting a ramp of a voltage rise in the off state of the switch module; and
a varistor connected to the capacitor and the switch module in a parallel connection with the capacitor and the switch module, wherein the varistor is configured for clamping a maximum voltage applied to the converter breaker in the off state of the switch module.

20. A converter breaker for enabling a converter to tolerate a voltage surge, the converter breaker comprising:
a switch module configured to be transitioned between an on state and an off state, wherein the switch module is configured for allowing a conduction of a current through the switch module during the on state, wherein the switch module is configured for restricting the conduction of the current through the switch module in the off state;
a capacitor connected to the switch module in a parallel connection with the switch module, wherein the capacitor is configured for limiting a ramp of a voltage rise in the off state of the switch module; and
a varistor connected to the capacitor and the switch module in a parallel connection with the capacitor and the switch module, wherein the varistor is configured for clamping a maximum voltage applied to the converter breaker in the off state of the switch module, wherein the converter breaker comprises a number of converter breakers, wherein the converter comprises a number of H-bridge modules, wherein the number of H-bridge modules are cascadedly connected, wherein each of the number of converter breakers is configured to be serially connected to each of a number of H-bridge modules of the converter respectively.
